(19) United States
(12) Patent Application Publication
(10) Pub. No.: US 2014/0086806 A1
(43) Pub. Date: Mar. 27, 2014

(54) SYSTEMS AND METHODS FOR SYNTHESIZING MOLECULES ON SUBSTRATES

(71) Applicants: Zhiyong Li, Redwood City, CA (US); Philip J. Kuekes, Menlo Park, CA (US)

(72) Inventors: Zhiyong Li, Redwood City, CA (US); Philip J. Kuekes, Menlo Park, CA (US)

(21) Appl. No.: 13/881,081

(22) PCT Filed: Oct. 28, 2010
(86) PCT No.: PCT/US10/54551

§ 371 Date: Apr. 23, 2013

(51) Int. Cl. B01J 19/08

(52) U.S. Cl. CPC B01J 19/087
USPC 422/199

(57) ABSTRACT

Systems and methods for synthesizing molecules on a substrate surface are disclosed. In one aspect, a molecule synthesizing system includes a crossbar array with a planar arrangement of crossbar junctions. Each crossbar junction is independently switchable between a high-resistance state and a low-resistance state. The system also includes a slab with a first surface and a second surface parallel to the first surface. The second surface is disposed on the crossbar array. A current applied to a crossbar junction in a high-resistance state creates an adjacent heated site on the first surface for attaching thermally reactive molecules for molecular synthesis.

### TECHNICAL FIELD

This disclosure relates to molecular synthesis and memristive crossbar devices.

### BACKGROUND

In recent years, it has become increasingly desirable to synthesize molecules at particular locations of a substrate surface with accuracy on the order of 10s of nanometers or less. Techniques based on dip-pen nanolithography or inkjet micropipette technology have recently emerged far synthesizing molecules at substrate locations with an accuracy of about 100 nanometers or less. With dip-pen nanolithography, molecular printing tips attached to a robotic arm are dipped into solutions containing chemical compounds that act as “ink,” The compounds attached to the tips are deposited at dewed locations of a substrate surface by placing the tips into close contact with the locations. With ink-jet micropipette technology, each tip is fluidly connected to a reservoir in which a compound is stored and includes a hole from which the compound is injected onto the desired location. However, these techniques are often cumbersome, time consuming, and can produce inaccurate synthesis and placement of molecules. Chemists and materials scientists continue to seek alternative techniques for synthesizing molecules at locations of a substrate with increased nanoscale precision.

### BRIEF DESCRIPTION OF THE DRAWINGS

FIG. 1A shows an isometric view an example molecule synthesizing system.

FIG. 1B shows a cross-sectional view of the example molecule synthesizing system along a line A-A shown in FIG. 1A.

FIG. 2 shows an isometric view of an example crossbar array of a molecule synthesizing system.

FIG. 3 shows an isometric view of an example memristive crossbar junction of a crossbar array.

FIG. 4 shows an example plot of current versus voltage for a typical nanoscale memristive crossbar junction.

FIGS. 5A-5B show isometric and cross-sectional views, respectively, of a molecule synthesizing system operated to heat a site of a slab of a molecule synthesizing system.

FIGS. 6A-6D show an example of synthesizing a molecule at a site of a slab of a molecule synthesizing system.

FIG. 7 shows an example of four molecules attached to four sites of a molecule synthesizing system slab.

FIG. 8 shows an example of a first set of four molecules attached to four sites of a molecule synthesizing system slab and a second set of molecules attached to four sites of the same slab.

FIG. 9 shows an example molecule synthesizing system used to generate long chain molecules.

FIG. 10 shows an example of a molecule synthesizing system used to create solid state structures.

FIGS. 11A-11D shows four examples of molecular patterns formed on as slab of a molecule synthesizing system.

FIG. 12 shows a flow diagram summarizing a method for synthesizing molecules using a molecule synthesizing system.

### DETAILED DESCRIPTION

This disclosure is directed to systems and methods for synthesizing molecules on a substrate. The systems include a porous substrate disposed on a memristive crossbar array. Thermally reactive molecules are grown at selected sites of the substrate surface by Joule heating corresponding crossbar junctions of the crossbar array. Joule heated crossbar junctions in turn heat adjacent selected sites of the substrate enabling attachment and synthesis of the thermally reactive molecules.

Molecule Synthesizing Systems

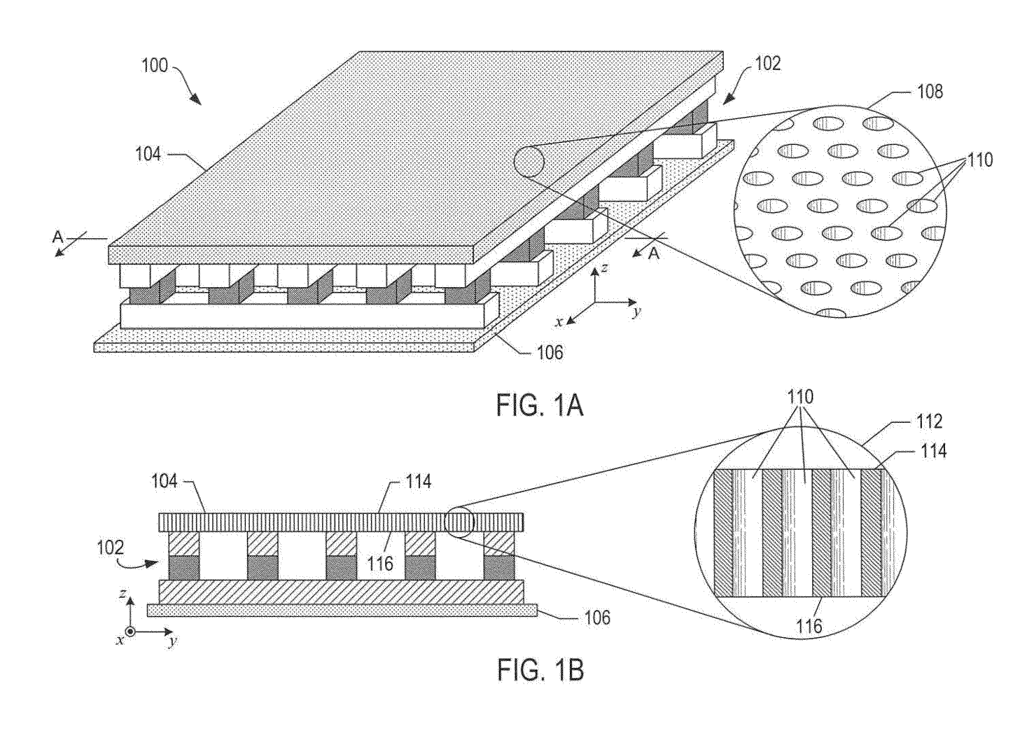

FIG. 1A shows an isometric view of an example molecule synthesizing system 100. The system 100 includes a crossbar array 102 disposed between a planar slab 104 and an insulating substrate 106. FIG. 1A also includes an enlarged isometric view 108 of the slab 104 outer surface which reveals the slab 104 is composed of a porous material. In particular, the slab 104 includes a two-dimensional lattice of pores 110 arranged in the xy-plane of the slab 104. FIG. 1B shows a cross-sectional view of the slab 104 along a line A-A shown in FIG. 1A. FIG. 1B also includes an enlarged cross-sectional view 112 of the slab 104 and shows the pores 110 extending through the slab 104 in the z-direction. In other words, the pores 110 are oriented substantially perpendicular to a First outer planar surface 114 and a second planar surface 116 of the slab 104 located adjacent to the crossbar array 102.

The pores 110 are not limited to the two-dimensional lattice arrangement shown in FIGS. 1A-1B. Other suitable regular lattice arrangements of the pores 110 include hexagonal, square, rhombic, rectangular, and parallelogrammic. The lattice of pores 110 can also have an irregular or random arrangement in the xy-plane of the slab 104. It may also be the case that not all of the pores 110 extend through the slab 104. In practice, only a portion of the pores 110 may extend the entire distance between the first and second surfaces 114 and 116. The pores 110 are also not limited to a circular cross-sectional geometry, as shown in FIG. 1A. The pores 110 can have elliptical, square, rectangular, irregular, or more complex cross-sectional geometries, and the cross-sectional geometry and size of each pore can vary within the same slab 104. The arrangement, spacing, diameter, and cross-sectional geometry of the pores 110 may also depend on the composition of the slab 104. For example, the slab 104 can be composed of porous alumina having a hexagonal lattice of pores with an interpore distance ranging from about 50 to about 500 nm. The slab 104 can also be composed of a zeolite with pores arranged in the xy-pane and extending in the z-direction.

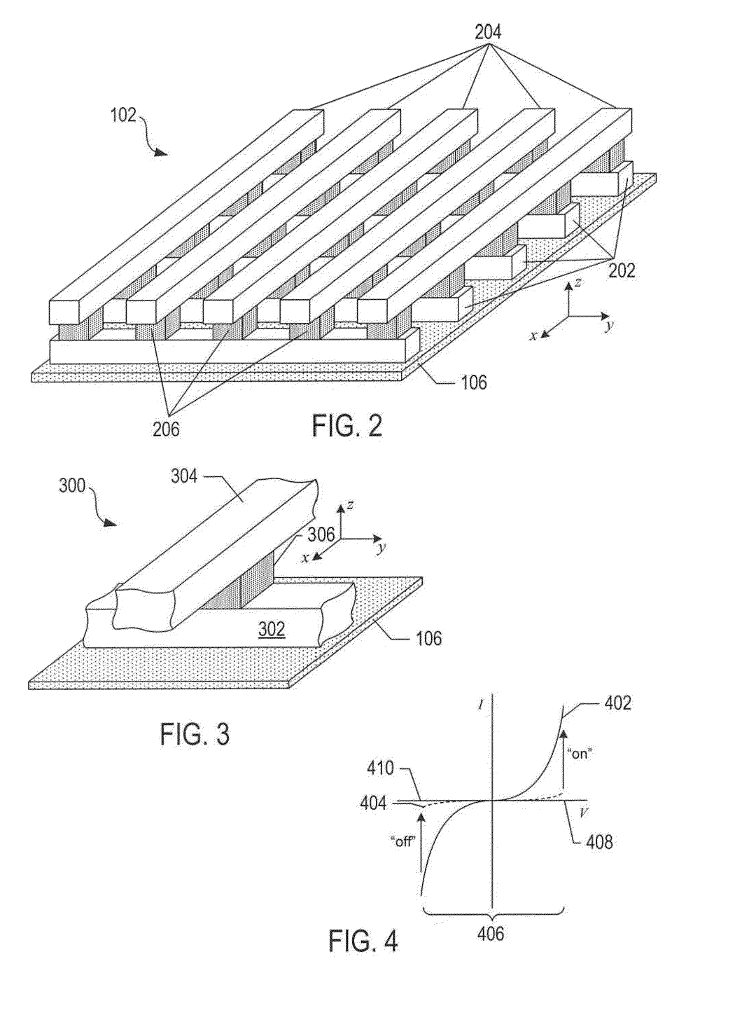

FIG. 2 shows an isometric view of the crossbar array 102 portion of the system 100 disposed on the insulating substrate 106. The crossbar array 102 includes a first layer of approximately parallel nanowires 202 disposed on the substrate 106 and is overlain by a second liner of approximately parallel nanowires 204. In the example of FIG. 2, the nanowires of the second layer 204 are approximately perpendicular in orientation to the nanowires of the first layer 202, although in practice the orientation angle between the layers may vary. The two layers of nanowires form a lattice, or crossbar, where each nanowire of the second layer 204 overlays substantially all of the nanowires of the first layer 202 and comes into close contact with each nanowire of the first layer 202 at nanowire intersections that represent the closest contact between two nanowires. At each nanowire intersection, a junction composed of a nonvolatile resistive switching material is disposed between the two overlapping nanowires to form a memristive crossbar junction. For example, as shown in FIG. 2, junctions 206 form three memristive crossbar junctions.

Although the nanowires of the crossbar array 102 are shown with rectangular cross sections, nanowires can also have square, circular, elliptical, or more complex cross-sectional geometries. The nanowires may also have many different widths, diameters, aspect ratios, or eccentricities. The term “crossbar” may refer to crossbars having at least two layers of nanowires, sub-microscale wires, microscale wires, or wires with larger dimensions.

FIG. 3 shows an isometric view of an example memristive crossbar junction 300 of the crossbar array 102 disposed on the insulating substrate 106. The crossbar junction 300 is a memristor composed of a first layer nanowire 302 that serves as a fast electrode 302, a second layer nanowire 304 that serves as a second electrode, and a junction 306 disposed between the nanowires 302 and 304. The junction 306 is composed of a nonvolatile material that can be switched between different resistance states when a voltage of an appropriate magnitude and polarity is applied to at least one of the nanowires 302 and 304.

A memristive crossbar junction can be switched between two resistive states that can be maintained for long periods of time, such as days, weeks, months, and possibly years. FIG. 4 shows an example plot of current l versus voltage V for a typical nanoscale memristive crossbar junction. Solid curve 402 represents the current of the memristor in a low-resistance state, and dashed nonlinear curve 404 represents the memristor in a high-resistance state. Applying voltages that fall within the voltage range 406 have negligible effect on changing the resistive state of the memristor and are used as operating voltages. On the other hand, larger magnitude voltages that fall outside the range 406 can be applied to switch the memristor's resistance state. For example, applying a positive voltage greater than the positive “on” threshold 408 switches the memristor from the high-resistance state 404 into the low-resistance state 402, and applying a negative voltage less than the negative “off” threshold 410 switches the memristor from the low-resistance state 402 into the high-resistance suite 404. The terms “positive” and “negative” refer to voltages with opposite polarities.

When a memristive crossbar junction is in the high-resistance state 404, applying a voltage in the operating range 406 to one of the nanowires 302 or 304 and ground to the other nanowire creates a current that enters the crossbar junction. Because the crossbar junction is in a high-resistance state, the amount current flowing out of the crossbar junction is low, and the energy carried by the current is released from the crossbar junction as heat in a process called “Joule” or “resistive heating.” In other words, when an appropriate current is applied to a memristive crossbar junction in a high-resistance state, the crossbar junction heats up and dissipates the heat to the surroundings. On the other hand, when the memristive crossbar junction is in the low-resistance state 402, applying a voltage in the operating range 406 also creates a current that enters the crossbar junction. But, because the crossbar junction is in a low-resistance state, the current flows through the crossbar junction with less resistance resulting in a nominal heating of the crossbar junction.

Referring to FIG. 3, the junction 306 includes dopants that, depending on how the dopants are distributed, affect the resistance state of the memristive crossbar junction 300. The basic mode of operation of a memristive crossbar junction 300 is that when a voltage of an appropriate magnitude and polarity is applied to at least one of the nanowires 302 and 304 an electrical field, also called a “drift field,” is generated across the junction 306. When the magnitude of the drift field exceeds a drift threshold, the dopants within the junction 306 become mobile and drift in and out of different sub-regions of the junction 306. For example, creating a drift field that drives dopants from a first sub-region into a second sub-region changes the resistance of the first and second sub-regions. In other words, the junction 306 can be switched from a high-resistances state to as low-resistance state, as described above with reference to FIG. 4, by causing the dopants to drift into different sub-regions of the junction 306. The composition of the junction and dopants are selected so that dopant drift in or out of different sub-regions of the junction is possible but not too facile in order to prevent dopants from diffusing in or out of different regions of the junction when no voltage is applied. In other words, one potentially useful property of the junction 108 is that it can be a weak ionic conductor. The definition of a weak ionic conductor depends on the intended use of memristive crossbar junction 300, The mobility μ_{d} and the diffusion constant D of a dopant in a lattice material are related by Einstein's equation:

D=μ_{d}kT

where k Boltzmann's constant, and T is an absolute temperature. If the mobility μ_{d} of a dopant in a lattice is high so is the diffusion constant D. In general, it is desirable for the junction 306 of the memristive crossbar junction 300 to maintain a particular resistance state for an amount of time that may range from a fraction of a second to years, depending on the application. This is accomplished by selecting the junction 306 materials and dopants so that the dopant mobility μ_{d} and the diffusion constant D are small enough to ensure the stability or non-volatility of the junction 306 for as long as necessary under the desired conditions. As a result, changes in the resistance state of the junction 306 that are due to ionized dopant diffusion can be avoided, and the resistance state of the junction 306 can be intentionally set with an appropriate voltage. This ensures that the junction 306 is nonvolatile by retaining its resistance state even after the drift field has been removed. On the other hand, strongly ionic conductors have relatively larger dopant mobilities and may be unstable against diffusion. Note that this relationship breaks down for high electric fields, which causes the mobility to become exponentially dependent on the field.

Memristive crossbar junctions can be composed of a variety of different semiconductor materials in combination with a variety of different electrode compositions. These combinations of materials provide a large materials space from which memristor devices can be fabricated and can be fabricated using various fabrication techniques.

The junction 306 can be composed of an elemental and/or compound semiconductor. Elemental semiconductors include silicon (“Si”), germanium (“Ge”), and diamond (“C”). Compound semiconductors include group IV compound semiconductors, III-V compound semiconductors, and II-VI compound semiconductors. Group IV compound semiconductors include combinations of elemental semiconductors, such as SiC and SiGe. III-V compound semiconductors are composed of column IIIa elements selected from boron (“B”), aluminum (“Al”), gallium (“Ga”), and indium (“In”) in combination with column Va elements selected from nitrogen (“N”), phosphorus (“P”), arsenic (“As”), and antimony (“Sb”). III-V compound semiconductors are classified according to the relative quantities of III and V elements, such as binary compound semiconductors, ternary compound semiconductors, quaternary compound semiconductors. The junction 306 can be composed of other types of suitable compound semiconductors including II-VI ternary alloy semiconductors and II-V compound semiconductors.

The junction 306 dopants can be p-type impurities, which are atoms that introduce vacant electronic energy levels called “holes” to the electronic band gaps of the active region. These dopants are also called “electron acceptors.” In still other embodiments, the dopants in the secondary active layer 314 can be n-type impurities, which are atoms that introduce filled electronic energy levels to the electronic band gap of the active region. These dopants are called “electron donors.” For example, boron (“B”), Al, and Ga are p-type dopants that introduce vacant electronic energy levels near the valence band of the elemental semiconductors Si and Ge; and P, As, and Sb are n-type dopants that introduce filled electronic energy levels near the conduction band of the elemental semiconductors Si and Ge. In III-V compound semiconductors, column VI elements substitute for column V atoms in the III-V lattice and serve as n-type dopants, and column II elements substitute for column III atoms in the III-V lattice to form p-type dopants.

The junction 306 can also be composed of an oxide, and the dopants can be anion vacancies. In particular, the junction 306 can be composed of titania (“TiO₂”), zirconia (“ZrO₂”), and hafnia (“HfO₂”). Other composition for the junction 306 include alloys of these oxides in pairs or with all three of the elements Ti, Zr, and Hf present. For example, the junction 306 can be composed of TiₓZr_{y}HfₓO₂, where x+y+z=1. Related compounds include titanates, zirconates, and hafnates. For example, titanates includes ATiO₃, where A represents one of the divalent elements strontium (“Sr”), barium (“Ba”) calcium (“Ca”), magnesium (“Mg”), zinc (“Zn”), and cadmium (“Cd”). In general, the junction 306 can be composed of ABO₃, where A represents a divalent element and B represents Ti, Zr, and Hf. The junction 306 can also be composed of alloys of these various compounds, such as CaₐSr_{b}Ba_{c}TiₓZr_{y}Hf_{z}O₃, where a+b+c=1 and x+y+z=1. There are also a wide variety of other oxides of the transition and rare earth metals with different valences that may be used, both individually and as more complex compounds. In each case, the mobile dopant is an oxygen vacancy. An oxygen vacancy effectively acts as a positively charge n-type dopant with one shallow and one deep energy level. Because even a relatively minor nonstoiciometry of about 0.1% oxygen vacancies in TiO₂₋ₓ is approximately equivalent to 5×10¹⁹ dopants/cm³, modulating oxygen vacancy profiles have a strong effect on electron transport. The switching material 306 can also be composed of nitrides using the same cations listed above for the oxides, where the dopant is a nitrogen vacancy.

The insulating layer 106 can be composed of SiO₂, Al₂O₃, glass, quartz, a dielectric polymer, or any other suitable dielectric material.

The nanowires 302 and 304 can be composed of platinum (“Pt”), gold (“Au”), copper (“Cu”), tungsten (“W”), or any other suitable metal, metallic compound (e.g. some perovskites with or without dopants such as BaTiO₃ and Ba₁₋ₓLaₓTiO₃, PrCaMnO₃) or semiconductor. The nanowires 302 and 304 can also be composed of metallic oxides or nitrides, such as RuO₂, IrO₂, and TiN. The nanowires 302 and 304 can also be composed of any suitable combination of these materials. For example, in certain embodiments, the first nanowire 302 can be composed of Pt, and the second nanowire 304 can be composed Au. In other embodiments, the first nanowire 302 can be composed of Cu, and the second nanowire 304 can be composed of IrO₂.

Referring now to FIG. 2, the first layer of nanowires 202 can be formed by first depositing the nanowire material using chemical vapor deposition (“CVD”), sputtering, or wafer bonding followed by pattern the nanowires using nanoimprint lithography (“NIL”), e-beam lithography (“EBL”), x-ray lithography, photolithography, focused ion beam (“FIB”) lithography, extreme UV lithography. A switching material layer 206 can be deposited over the first layer of nanowires 202 using CVD or wafer bonding and can be patterned using NIL, EBL, x-ray lithography, photolithography, FIB lithography. Finally, the second layer of nanowires 204 can be formed in the same manner as the first layer of nanowires.

Synthesizing Molecules and Molecular Structures Using Molecule Synthesizing Systems

The molecule synthesizing system 100 can be used to synthesize molecules at particular locations or synthesize molecular structures over larger regions on the surface of the slab 104 by creating localized heated sites of the slab 104. In other words, the outer surface 114 of the slab 104 (shown in FIG. 1B) serves a substrate upon which molecules can be synthesized. The smallest heated site, about 10 nm to about 100 nm, of the slab 104 can be created by Joule heating of a single memristive crossbar junction. While a larger heated region of the slab 104 can be created by Joule heating a number of adjacent memristive crossbar junctions. In other words, a heated region of the slab 104 may correspond to a number heated sites.

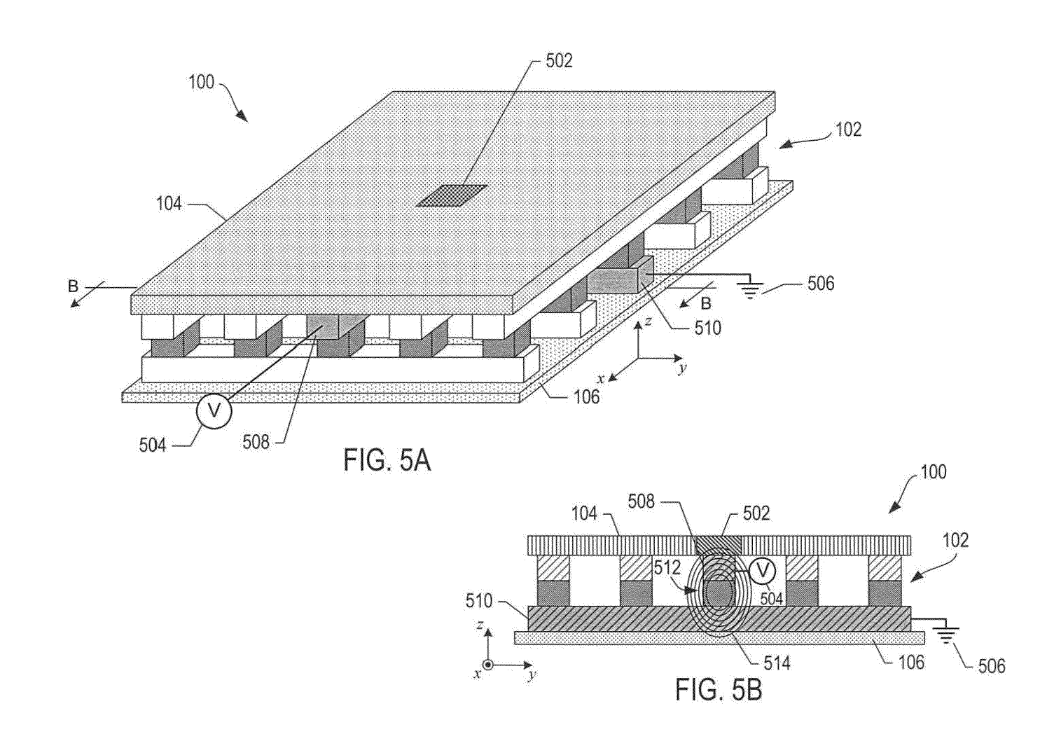

FIG. 5A shows an isometric view of the system 100 operated to heat a substrate site 502 of the slab 104. The site 502, typical of 20 nm to about 200 nm is heated by first switching the memristive crossbar junction located beneath the region 502 into a high-resistance state, as described above with reference to FIG. 4. In order to avoid heating other sites of the slab 104, crossbar junctions associated with these sites are switched in a low-resistance state. Next, an operating voltage 504 is applied to one of the two nanowires at the crossbar junction and a ground 506 is applied to the other of the two nanowires in order to create a current flowing into the crossbar junction. In the example of FIG. 5A, and in subsequent figures, the nanowires of a crossbar junction used to create a heated site of the slab 104 are shaded, such as darker shaded nanowires 508 and 510 associated with the crossbar junction located beneath the site 502. FIG. 5B shows a cross-sectional view of the crossbar junction 512 located beneath heated site 502. Because the crossbar junction 512 is in a high-resistance state, the current flowing into the crossbar junction 512 causes the crossbar junction 512 to heat up and dissipate heat represented by isotherms 514. As shown in FIG. 5B, the heat generated by the crossbar junction 512 penetrates the site 502. As described above with reference to FIG. 1, the slab 104 is composed of a lattice of pores extending substantially through the slab 104 in the z-direction. Because the axes of the pores are directed primarily in the z-direction, the slab 104 is heat insulating in the xy-plane and heat conducting in the z-direction. As a result, heat penetrating the slab 104 from the crossbar junction 512 is confined primarily to the site 502 adjacent to the crossbar junction 512.

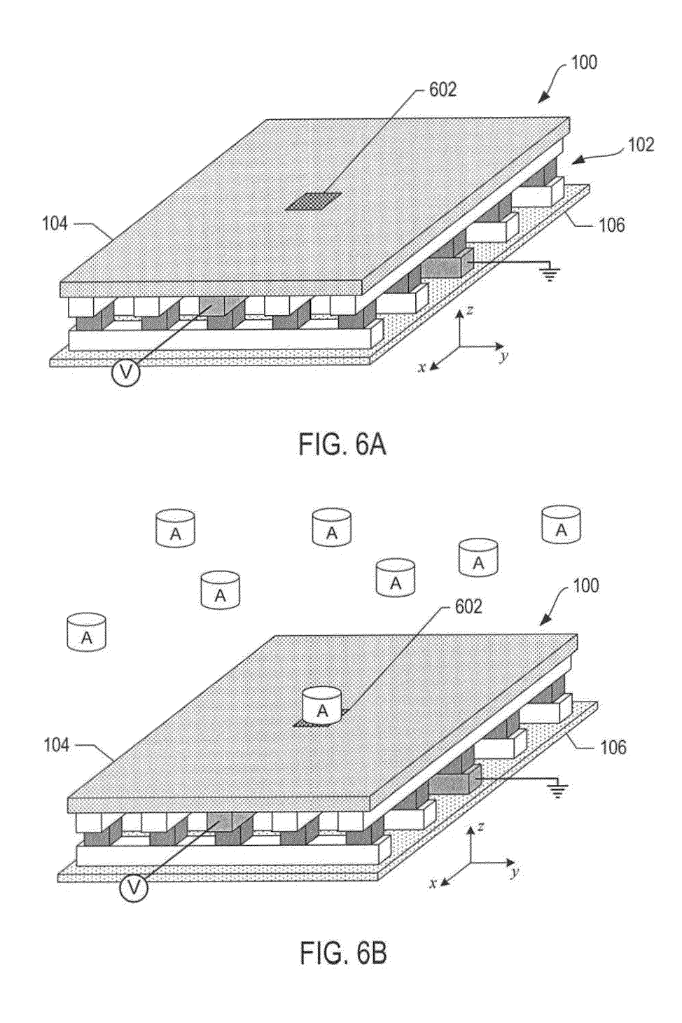

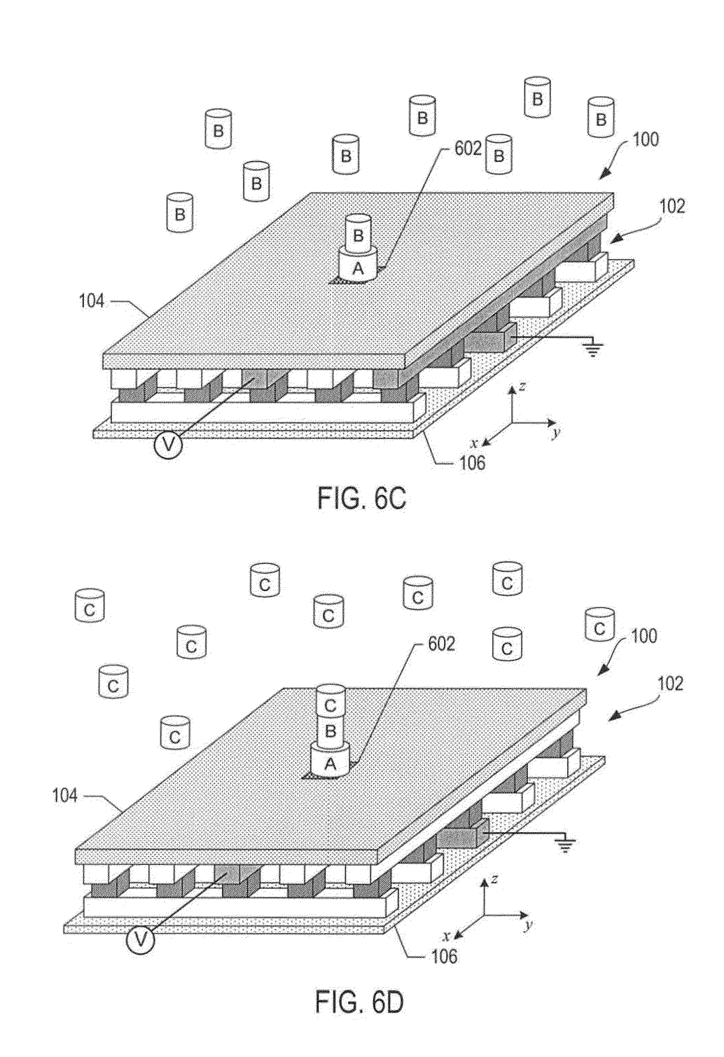

Thermally reactive molecules can be selectively synthesized at heated substrate sites of the slab 104. FIGS. 6A-6D show an example of synthesizing a molecule in cycles at a selected substrate site of the slab 104. In forming a molecule on the slab 104, the reactants react one at a time. The process can be self-limiting because the number of reactants deposited in each reaction cycle is nearly constant. The system 100 is placed in a reaction chamber that allows reactants used to synthesize a molecule of a particular composition to be introduced and evacuated from the chamber after each cycle. In FIG. 6A, after the system 100 has been placed in reaction chamber, the slab 104 is heated at a selected substrate site 602 as described above with reference to FIG. 5. to FIG. 6B, a first thermally reactive reactant A is input to the reaction chamber. Reactant A can attach to the heated site 602 in a number of different ways: (1) covalent bonding, ionic bonding, or Van der Waals forces can attach reactant A to the site 602. The reaction chamber is evacuated to remove any un-reacted reactant A molecules or other by-products. In FIG. 6C, a second reactant B is input to the reaction chamber. The reaction between reactant Baud reactant A to produce a product AB can be thermally reactive, in which case the site 602 remains heated while the reactant B is input to the reaction chamber and allowed to react with reactant A to form the product molecule AB. Alternatively, if reactant B does not require additional thermal energy to react with reactant A, and reactant A can remain attached to the site 602 without heating the site 602 and heating the site 602 can be stopped. The reaction chamber is evacuated to remove any un-reacted reactant B molecules or other by-products of the reaction. In FIG. 6D, a third reactant C is input to the reaction chamber. Reactant C can be thermally reactive the molecule AB, in which case the site 602 remains heated while the reactant C is input to the reaction chamber and allowed to react with the molecule AB to form product molecule ABC. Alternatively, if heating is not required to for the reactant C to react with molecule AB and the molecule AB can remain attached to the site 602, heating of site 602 can be stopped. The reaction chamber is evacuated to remove any un-reacted reactant C molecules or other by-products of the reaction.

Note that in the example of FIG. 6, for the sake of simplicity only one reactant A is shown attached to the heated site 602. In practice, a heated site, such as heated site 602, may actually be large enough to attach more than one reactant A molecule.

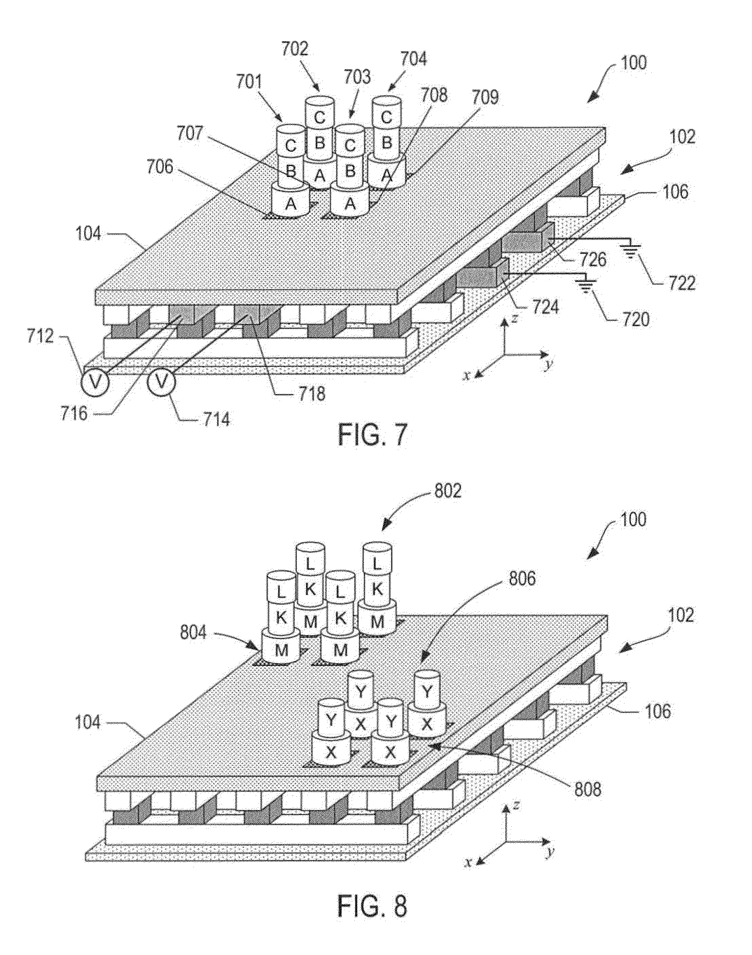

Methods of synthesizing molecules using the system 100 are not limited to synthesizing one molecule at a time at a selected site. The steps for synthesizing a single molecule at a selected site can be used to simultaneously synthesize a desirable number of identical molecules at different sites. FIG. 7 shows an example of four molecules ABC 701-704 attached to four different substrate sites 706-709. The molecules 701-704 can be synthesized by simultaneously applying voltages 712 and 714 to nanowires 716 and 718 and grounds 720 and 722 to nanowires 724 and 726 and repeating the steps described above with reference to FIG. 6. The four sites 706-709 represent a region of the slab 104 upon which molecules with the same composition are synthesized.

Methods of synthesizing molecules can also be used to synthesize different sets of identical molecules on different regions of the slab 104. FIG. 8 shows an example of a first set of four identical molecules MKL 802 attached to four substrate sites 804 of the slab 104 and a second set of identical molecules XY 806 attached to four different sites 808 of the slab 104. The first and second sets of molecules 802 and 806 can be synthesized separately, as described above with reference to FIGS. 6 and 7.

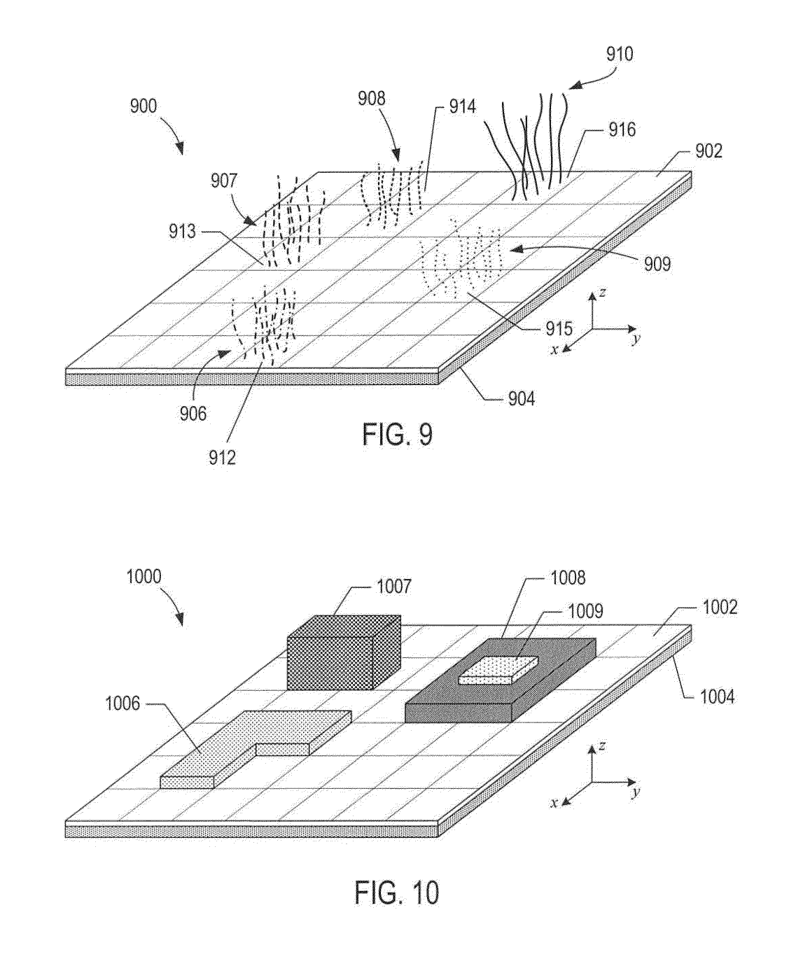

FIG. 9 shows an example molecule synthesizing system 900 including a slab 902 disposed on a crossbar array represented by a shaded region 904. The crossbar array 904 can include thousands or millions of memristive crossbar junctions that enable synthesis of long chain molecules attached to different regions of the slab 902. In the example of FIG. 9, five different sets of long chain molecules 906-910 are represented by different line patterns. Each set of molecules is attached to a different region 912-916 of the slab 902, and the molecule within each set is attached to different site within a region. The molecules within each region can be synthesized in the manner described above with reference to FIG. 6. The molecules of each set 906-910 can also represent hybridization probes used to detect the presence of nucleotide sequences that are complementary to the sequences of the probes.

Molecule synthesizing systems can also be used to synthesize solid state structures of varying thickness at different regions of a slab. FIG. 10 shows an example of a molecule synthesizing system 1000 including a slab 1002 disposed on a crossbar array represented by a shaded region 1004. The crossbar array 1004 can include thousands or millions of memristive crossbar junctions that enable the formation of solid state structures, such as the structures 1006-1009 on the surface of the slab 1002. Each solid state structure can be synthesized by selectively heating different region of the slab 1002 to attach the thermally reactive reactants that form the structure 1006-1009, as described above with reference to FIG. 6.

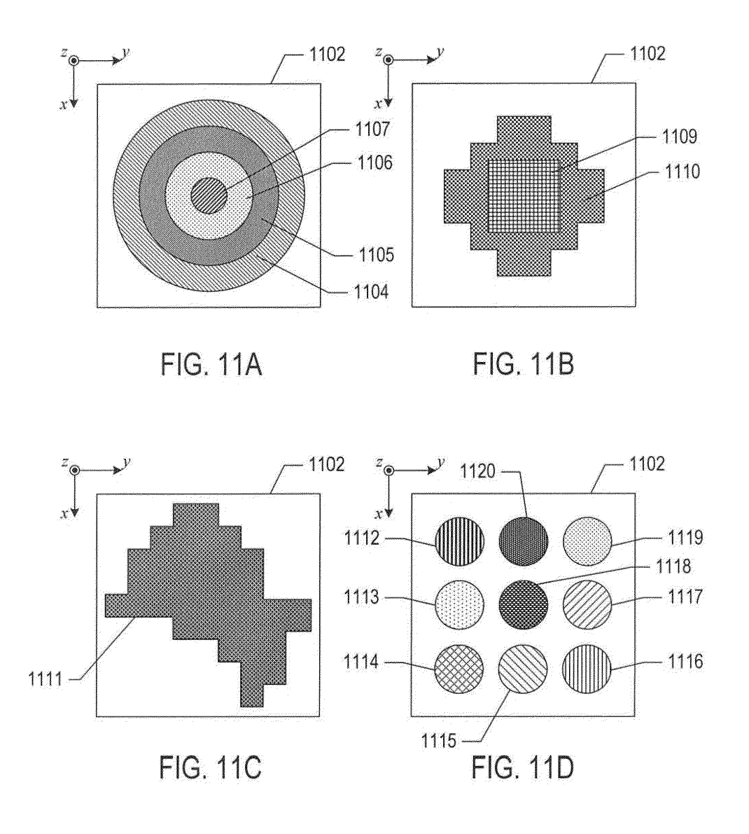

Molecule synthesizing systems can also be used to synthesize molecules and solid state structures with various patterns. FIGS. 11A-11D shows just four examples of molecular patterns that can be formed on a slab 1102 of molecule synthesizing system. In the examples of FIGS. 11A-11D, different shaded regions represent different types of molecules attached to the surface of the slab 1102. In FIG. 11A, four different types of molecules 1104-1107 are synthesized on the surface of the slab 1102, three of which are concentric annular rings that form a bulls-eye pattern. In FIG. 11B, two different types of molecules 1109 and 1110 are synthesized to create a symmetric pattern. In FIG. 11C, one type of molecule 1111 is synthesized to create an asymmetric pattern. In FIG. 11D, nine different types of molecules 1112-1120 are attached and arrange in an array of circular spots, each spot is composed of one type of molecule.

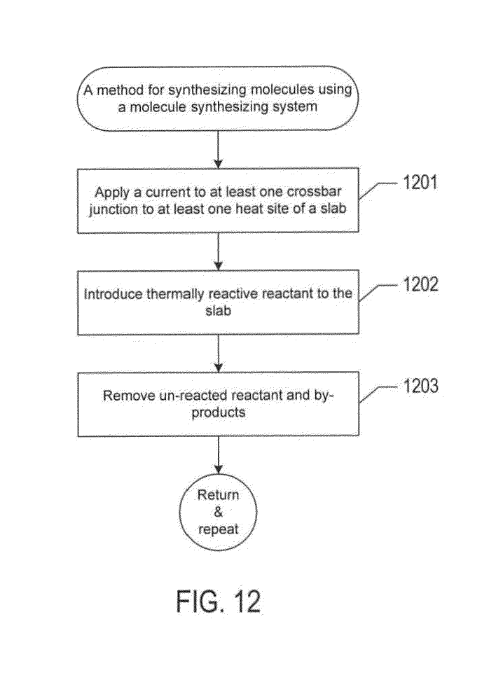

FIG. 12 shows a flow diagram summarizing a method for synthesizing molecules using a molecule synthesizing system. In step 1201, at least one crossbar junction of a crossbar array is switched into a high resistance state, as described above with reference to FIGS. 5 and 6A. In step 1202, a current is applied to each of the at least one crossbar junctions in order to heat at least one site of the outer surface of the slab, as described above with reference to FIG. 6A. In step 1203, a thermally reactive reactant is introduced to the slab and the reactant attaches to the at least one heated site, as described above with reference to FIG. 6B. In step 1204, un-reacted reactants and by-products are removed, as described above with reference to FIGS. 6B-6D.

The foregoing description, for purposes of explanation, used specific nomenclature to provide a thorough understanding of the disclosure. However, it will be apparent to one smiled in the art that the specific details are not required in order to practice the systems and methods described herein. The foregoing descriptions of specific embodiments are presented for purposes of illustration and description. They are not intended to be exhaustive of or to limit this disclosure to the precise forms described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A molecule synthesizing system comprising:
a crossbar array having a planar arrangement of crossbar junctions, each crossbar junction independently switchable between a high-resistance state and a low-resistance state; and
a slab having a first surface and a second surface parallel to the first surface, the second surface disposed on the crossbar array, wherein a current applied to a crossbar junction in a high-resistance state creates an adjacent heated site on the first surface for attaching thermally reactive molecules for molecular synthesis.

2. The system of claim 1, wherein each crossbar junction further comprises a memristor.

3. The system of claim 1, wherein the crossbar array further comprises
a first layer of approximately parallel wires;
a second layer of approximately parallel wires overlaying the first layer, wherein each wire of the second layer overlays substantially all of the wires of the first layer; and
a junction disposed between each pair of overlapping wires.

4. The system of claim 1, wherein the slab further comprises a porous material with a regular lattice of pores oriented substantially perpendicular to the crossbar array.

5. The system of claim 1, wherein the slab further comprises a porous material with an irregular lattice of pores oriented substantially perpendicular to the crossbar array.

6. The system of claim 1, wherein the slab is heat insulating parallel to the first and second surfaces and heat conducting perpendicular to the first and second surfaces.

7. A molecule synthesizing system comprising:
a memristor switchable between a high-resistance state and a low-resistance state; and
a porous material disposed on the memristor, the porous material having an outside surface, wherein when the memristor is in a high-resistance state, a current applied to the memristor creates a heated site in the outside surface enabling attachment of thermally reactive molecules to the heated site.

8. The system of claim 7, wherein the memristor further comprises:
a first electrode disposed on an insulating surface;
a junction disposed on the first electrode; and
a second electrode disposed between the junction and the porous material.

9. The system of claim 7, wherein the porous material is heat insulating parallel to the memristor and heat conducting perpendicular to the memristor.

10. The system of claim 7, wherein the porous material further comprises a regular lattice of pores oriented substantially perpendicular to the crossbar array.

11. The system of claim 7, wherein the porous material further comprises an irregular lattice of pores oriented substantially perpendicular to the crossbar array.

12. A method for synthesizing molecules, the method comprising:
providing slab having a first surface and a second surface oriented parallel to the first surface, the second surface disposed on crossbar array having a planar arrangement of crossbar junctions;
switching at least one crossbar junction into a high-resistance state;
applying a current to each of the at least one crossbar junction to heat at least one site of the first surface; and
introducing a first thermally reactive reactant to the slab, the reactant able to attach to the at least one heated site.

13. The method of claim 12 further comprising
removing un-reacted reactants; and
introducing a second thermally reactive reactant to the slab, the second reactant reacting with the first reactant attached to the at least one heated site.

14. The method of claim 12, wherein the slab further comprises a porous material with pores oriented substantially perpendicular to the crossbar array.

15. The method of claim 12, wherein the slab is heat insulating parallel to the first and second surfaces and heat conducting perpendicular to the first and second surfaces.
